(19) United States
(12) Patent Application Publication
(10) Pub. No.: US 2026/0333250 A1
(43) Pub. Date: Oct. 22, 2026

(54) Wireless Communication of a Motor Vehicle with a Mobile Device

(71) Applicant: Bayerische Motoren Werke Aktiengesellschaft, Muenchen (DE)

(72) Inventors: Adem CEYLAN, Muenchen (DE); Atanas Lyutskanov, Muenchen (DE); Alaa Mourad, Muenchen (DE)

(21) Appl. No.: 19/568,135

(22) Filed: Mar. 16, 2026

(30) Foreign Application Priority Data
Apr. 16, 2025 (DE) 10 2025 115 031.1

(51) Int. Cl. H04W 52/38; B60R 16/03; H04W 4/40

(52) U.S. Cl. CPC H04W 52/38; B60R 16/03; H04W 4/40

(57) ABSTRACT

A method for wireless communication of a motor vehicle with a mobile device includes steps of determining a transmission situation of the motor vehicle for radio waves; and adapting a transmitting power of at least one wireless transmission device of the motor vehicle depending on the determined transmission situation, in order to reduce an overall energy consumption of the at least one transmission device.

### CROSS REFERENCE TO RELATED APPLICATION

This application claims priority under 35 U.S.C. § 119 from German Patent Application No. 10 2025 115 031.1, filed Apr. 16, 2025, the entire disclosure of which is herein expressly incorporated by reference.

### BACKGROUND AND SUMMARY

The present invention relates to the wireless communication of a motor vehicle with a mobile device. In particular, the invention relates to saving energy for the operation of a wireless communication device on board a motor vehicle.

A motor vehicle comprises one or more transmission devices by means of which wireless communication with a mobile device can be established. A transmission device can function, for example, according to the Bluetooth low energy (BLE) standard and permit communication over distances of approximately 100 m or more. The communication can be used to control a welcome function of the motor vehicle. If a user approaches with a mobile device known to the motor vehicle, the motor vehicle can thus be prepared for use. Internal or external lighting can be switched on, an entertainment or information system can be started, or an electrical energy storage device can be thermally conditioned.

To establish the communication, the motor vehicle typically emits wireless signals periodically to which the mobile device can respond. The emission requires a certain amount of electrical energy which can be provided by a vehicle battery of the motor vehicle. Modern motor vehicles can have more than one transmission device, and cumulative energy consumption of all transmission devices can be substantial if the motor vehicle is parked over a longer time.

One object underlying the present invention is to provide an improved technology for saving energy for operating a wireless transmission device on board a motor vehicle. The invention achieves this object by means of the subjects of the independent claims. Dependent claims provide preferred embodiments.

According to a first aspect of the present invention, a method for wireless communication of a motor vehicle with a mobile device comprises steps of determining a transmission situation of the motor vehicle for radio waves; and adapting a transmitting power of at least one wireless transmission device of the motor vehicle depending on the determined transmission situation, in order to reduce a total energy consumption of the at least one transmission device.

The transmission situation applies for the motor vehicle and can depend on a large number of parameters. The transmission situation can comprise influences on a propagation or transmission of radio waves which are emitted by the transmission device. The transmission device can operate according to a predetermined, known standard for wireless communication, for example, Bluetooth low energy (BLE) or ultra-wideband (UWB). The transmission situation is typically related to a transmission link or a Fresnel zone between the motor vehicle and the mobile device. The adaptation of a transmitting power generally comprises changing a transmitting power of at least one transmission device for the purpose of reducing the overall energy consumption of all transmission devices of the motor vehicle. Communication quality is not to be worsened in this case if possible.

The consideration of the transmission situation can prevent a transmission device from being operated disadvantageously. The operation of a transmission device can be adapted to the transmission situation, by which energy can be saved overall. An energy storage device of the motor vehicle, from which the at least one transmission device is powered, can thus be strained less. At a given capacity of the energy storage device, operation of the at least one transmission device can be maintained over a longer time. A function of the motor vehicle coupled to the communication between the mobile device and the motor vehicle can thus be offered over a longer period.

Transmission devices are preferably provided at different positions of the motor vehicle. A transmitting power of a transmission device is preferably adapted depending on its position and the determined transmission situation. It can thus be decided individually for each of multiple transmission devices at which transmitting power they are to operate. A transmission device, the position of which on the motor vehicle is advantageous with respect to the transmission situation, can be operated using unchanged or even increase transmitting power, while another transmission device, the position of which with respect to the transmission situation is disadvantageous, can be reduced in its transmitting power or switched off completely. A communication capacity of the motor vehicle with the mobile device can thus not be reduced or not significantly reduced, while the energy consumption for the transmission devices can be reduced overall.

It is furthermore preferred for a ratio of transmitting powers of different transmission devices to be adapted. In other words, it is preferred that the reduction of the transmitting power of a first transmission device does not automatically mean an increase of the transmitting power of a second transmission device. Even if a corresponding increase of the transmitting power takes place, the adaptation preferably takes place in such a way that a sum of energy consumptions of all available wireless transmission devices of the motor vehicle is reduced overall by the adaptation to the transmission situation.

In one variant, the transmission situation comprises the mobile device being located in an interior of the motor vehicle. A transmitting power of a transmission device of the motor vehicle can be adapted so that communication with a mobile device outside the interior is made more difficult. For this purpose, a transmitting power of a transmission device can be reduced enough that the communication with the mobile device located in the interior of the motor vehicle is enabled, but communication with a mobile device outside the motor vehicle is made more difficult at the same time.

A communication distance between a mobile device outside the motor vehicle and the motor vehicle is thus reduced. Ideally, the communication with the mobile device outside the motor vehicle is practically no longer possible at all. The fact can be utilized here that the motor vehicle can act as a Faraday cage with respect to radio waves which a transmission device emits. A first transmission device configured for communication with the mobile device in the interior can practically not be used for communication with a mobile device outside the interior in this case. Vice versa, a second transmission device can be provided, which is configured for communication with a mobile device in the exterior of the motor vehicle. The second transmission device can then practically not be used for communication with a mobile device in the interior.

If it is known that a mobile device which is to be communicated with is located in the interior, the described first transmission device can remain activated, while the second transmission device is limited in its transmitting power or switched off completely. Vice versa, if it is known that the mobile device is located outside the motor vehicle, the first transmission device can be restricted in its transmitting power or switched off, while the second transmission device remains activated.

In a further variant, the transmission situation comprises that the motor vehicle is surrounded in the horizontal direction by building structures. The transmitting power of a transmission device of the motor vehicle can be reduced in this case. In particular, transmitting powers of all transmission devices of the motor vehicle can be reduced. This situation typically occurs when the motor vehicle is located in a garage or underground garage. Building structures which surround the motor vehicle can strongly reflect radio waves, so that a communication range of a mobile device to the motor vehicle can be practically increased. The reduction of the transmitting power of at least one transmission device can save energy for operating the transmission device without loss of communication range.

The transmission situation can also comprise that the motor vehicle is located in a building. In particular, the motor vehicle can be located in a roofed building such as a parking facility. Where the motor vehicle is located with respect to a building structure or a building can be determined easily with respect to a geographic position of the motor vehicle and map data which comprise buildings in the area of the geographic position. Other determination options are also possible.

In still another variant, the transmission situation comprises that the motor vehicle is standing at an obstacle, wherein a transmitting power of a transmission device facing toward the obstacle is reduced. A transmitting power of a further transmission device, which is independent or facing away from the obstacle, can be kept constant or increased. The obstacle can be for the propagation of radio waves, so that an emission in the direction of the obstacle either causes absorption or reflection of the radio waves. The obstacle can also be for a person who could be approaching the motor vehicle with the mobile device.

In still another variant, the transmission situation comprises that an approach of the mobile device to the motor vehicle is only possible on a predetermined path. A transmitting power of a transmission device which is not configured to communicate with a mobile device located on the path can be reduced in this case. If the motor vehicle is located, for example, in a single-car garage, all transmitting power used can be directed in the direction of an entry door or a garage door. A person who approaches the motor vehicle with a mobile device is forced to use one of these entries, so that a communication coverage of an area which is located in another direction of the motor vehicle can be omitted. It is to be noted that the path possibly does not lead straight to the motor vehicle. It can therefore be necessary to supply a larger angle range from the motor vehicle with emitted radio waves in order to keep the entire path ready for communication for the mobile device up to a predetermined maximum distance.

According to still another variant, the transmission situation comprises that an approach of a mobile device to the motor vehicle from a predetermined direction is not to be expected, wherein a transmitting power of a transmission device configured to communicate with a mobile device located in the predetermined direction is reduced. Such a situation is present, for example, when the motor vehicle is located on a parking deck of a parking facility. An approach of a person with a mobile device through the air toward the motor vehicle is only theoretically possible and is practically not to be expected. In a similar manner, an area around the motor vehicle, from which the motor vehicle cannot be reached by a human with a mobile device, can be supplied more weakly or no longer at all with radio waves of a transmission device. Such a case can be present when the motor vehicle is standing, for example, at a fence or a wall. Access to the motor vehicle from beyond the fence or the wall cannot be expected in this case. It is to be noted that two or more of the variants described herein can also be present at the same time.

It is furthermore preferred for the method to be carried out on a parked motor vehicle. The motor vehicle can be configured to establish communication to the mobile device and to control a vehicle function on the basis of the communication. In particular, the mobile device can be authenticated before a function of the motor vehicle is controlled. Such a function can comprise, for example, a welcome function. In a further embodiment, the motor vehicle is secured by means of a digital key (DK). A predetermined security function, in particular opening a vehicle door or vehicle hatch or starting a drive motor, can only be controlled when an authentication between the mobile device and the motor vehicle has been carried out successfully. This authentication can take place wirelessly via a transmission device of the motor vehicle.

Preferably, the digital key is designed according to the proposals of the Car Connectivity Consortium (CCC) as are described in the corresponding technical specification (for example, Digital Key Release 3 or 4). According to a further aspect of the present invention, a device for a motor vehicle is configured for wireless communication with a mobile device. In this case, the device comprises at least one wireless transmission device; a device for determining a transmission situation of the motor vehicle; and a processing device configured to adapt a transmitting power of the at least one transmission device depending on the transmission situation in order to reduce an overall energy consumption of the at least one transmission device.

The processing device is preferably configured to partly or fully carry out a method described herein. For this purpose, the processing device can be electronic and include, for example, an integrated circuit, a programmable logic chip, or a programmable microcomputer. The method can be implemented in the form of a configuration or as a computer program product having program code means for the processing device. The configuration or the computer program product can be stored on a computer-readable data carrier. Features or advantages of the method can be transferred to the device or vice versa.

The device for determining the transmission situation can in particular comprise a positioning device configured to determine a geographic position of the motor vehicle. The device can furthermore comprise a map memory having map data. The map data can comprise objects in the area of the geographic position of the motor vehicle and/or paths, on which a person can approach the determined geographic position.

According to yet another aspect of the present invention, a motor vehicle comprises a device described herein. The motor vehicle can comprise a passenger vehicle, a truck, or a bus. The mobile device preferably comprises a smart phone; in further embodiments, however, it can also comprise another device. The device can be assigned to a person who is assigned to the motor vehicle, for example as a driver or as a passenger. The device can be a personal device of the person. To use specific functions of the device, it can be necessary for a user to authenticate themself with respect to the device, for example, by inputting a predetermined secret or by presenting a biometric feature. In particular, the use of a digital key, using which a predetermined security function of the motor vehicle can be controlled, can be bound to the user authenticating themself with respect to the mobile device.

The invention will now be described in more detail with reference to the accompanying drawings.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 illustrates a system; and

FIG. 2 illustrates a flow chart of a method.

### DETAILED DESCRIPTION OF THE DRAWINGS

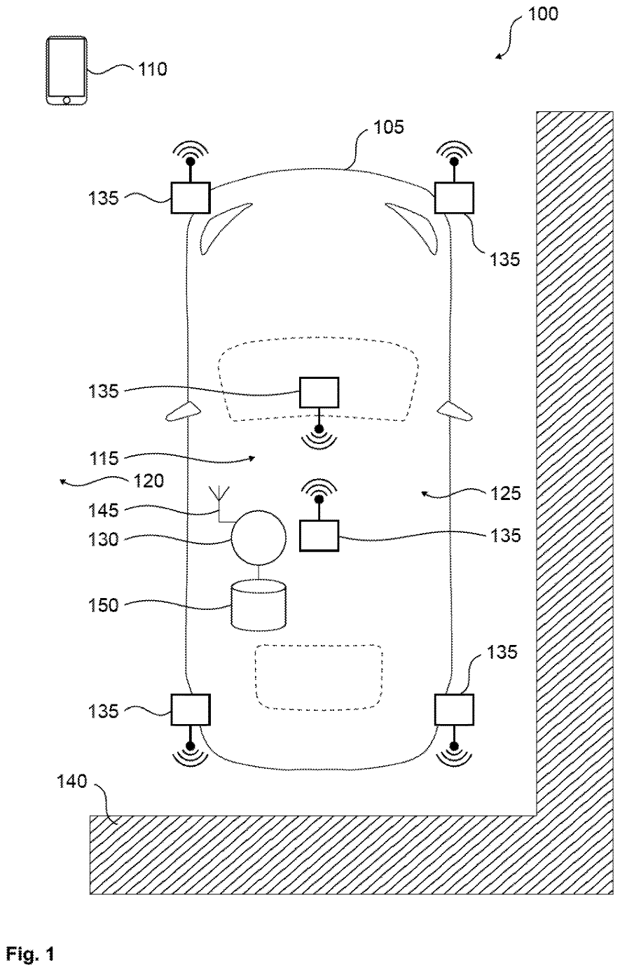

FIG. 1 shows a system 100 having a motor vehicle 105 and a mobile device 110. The motor vehicle 105 is shown by way of example as a passenger vehicle having an interior 115, in which a passenger can be located. The interior 115 can comprise a passenger compartment. An exterior 120 of the motor vehicle 105 is located outside the interior 115.

A device 125 configured to communicate wirelessly with the mobile device 110 is attached on board the motor vehicle 105. Communication can be possible in the interior 115 and/or in the exterior 120. The device 125 comprises a processing device 130 and at least one transmission device 135.

A transmission device 135 can be configured to enable communication with a mobile device 110 in the interior 115 and/or in the exterior 120. Multiple transmission devices 135 are preferably provided, which can occupy different positions on the motor vehicle 105. Solely by way of example, the motor vehicle 105 shown in FIG. 1 comprises four transmission devices 135, which are configured for communication in the exterior 120 and are also called external transmission devices 135 herein. These transmission devices 135 are attached on the motor vehicle 105 by way of example on the front left, front right, rear left, and rear right. Furthermore, two transmission devices 135 are provided, which are configured for communication with a mobile device 110 in the interior 115. These transmission devices 135 are also designated herein as internal transmission devices 135.

The processing device 130 is configured to control transmitting powers of the transmission devices 135 of the motor vehicle 105. Preferably, an individual control of the transmitting powers of each individual transmission device 135 is possible. However, multiple transmission devices 135 can also be combined to form a group, wherein transmitting powers of the transmission devices 135 of a group can only be controlled jointly. Exemplary groups comprise only the internal transmission devices 135 or only the external transmission devices 135.

A transmission device 135 can also be called a transceiver and typically comprises at least one antenna and a device using which electrical signals can be received and on the basis of these signals radio waves can be emitted. The device can also be used to convert radio waves received by means of the antenna into electrical signals. Depending on the wireless transmission technology used, the conversion between electrical signals and radio waves can be more or less complex. It is generally preferred for a transmission device 135 to operate according to a predetermined communication standard, in particular BLE or UWB.

In the illustration of FIG. 1, the motor vehicle 105 stands by way of example at an object 140 on two sides (rear and right). The object 140 can comprise a building structure, for example a wall or a column. The object 140 can form an obstacle which influences a transmission situation of the motor vehicle 105. In one embodiment, the object 140 forms an obstacle for radio waves and can absorb or reflect radio waves. In a further embodiment, the object 140 forms an obstacle for a person who could approach the motor vehicle 105 with the mobile device 110. The cases can also be present simultaneously.

In both cases, it can be determined that it is disadvantageous or superfluous to emit radio waves in the direction of the object 140. In the illustration of FIG. 1, the transmission device 135 on the right rear on the motor vehicle 105 can be reduced in its transmitting power or switched off completely. Transmission devices 135 which are attached on the motor vehicle 105 on the left rear or right front can be operated further with slightly reduced transmitting power. The external transmission device 135, which is attached at the left front on the motor vehicle 105, does not face toward any section of the object 140 shown and can be operated further in a familiar manner or even increased it its transmitting power. If the mobile device 110 is not located in the interior 115, a transmitting power of an internal transmission device 135 can be reduced, or the internal transmission devices 135 can be switched off. An overall energy consumption of the transmission devices 135 can be reduced by changing the transmitting powers of all transmission devices 135.

In another variant, the mobile device 110 is located in the interior 115 of the motor vehicle 105. In this case, the internal transmission devices 135 can be operated further, while the external transmission devices 135 can be reduced in their transmitting powers or switched off completely.

Different sensors can be provided on the motor vehicle 105 for determining where an object 140 is located in the area of the motor vehicle 105. In one embodiment, a camera is attached to the motor vehicle 105, by means of which the surroundings of the motor vehicle 105 can be scanned. An object 140 in the area of the motor vehicle 105 can be determined via image recognition. In particular a direction and/or a size of the object 140 can be determined in this case. In addition, properties of the object 140 can be determined, for example whether the object 140 represents an obstacle to radio waves or to a person.

In a further embodiment, the device 125 comprises a positioning device 145 for determining a geographic position of the motor vehicle 105 and a map memory 150. The positioning device 145 can comprise a receiver of a global satellite-based navigation system (GNSS). Alternatively, a geographic position of the motor vehicle 105 can also be determined differently, for example by means of an inertial system (Inertial Measurement Unit, IMU), an odometer, or via SLAM (Simultaneous Localization And Mapping). Information about objects 140 in the area of the motor vehicle 105 is stored in the map memory 150. Such objects 140 can comprise buildings or points of interest. In addition, roads or paths can be noted. Attributes can be saved for a stored object 140, for example, a material, an extension, or a purpose.

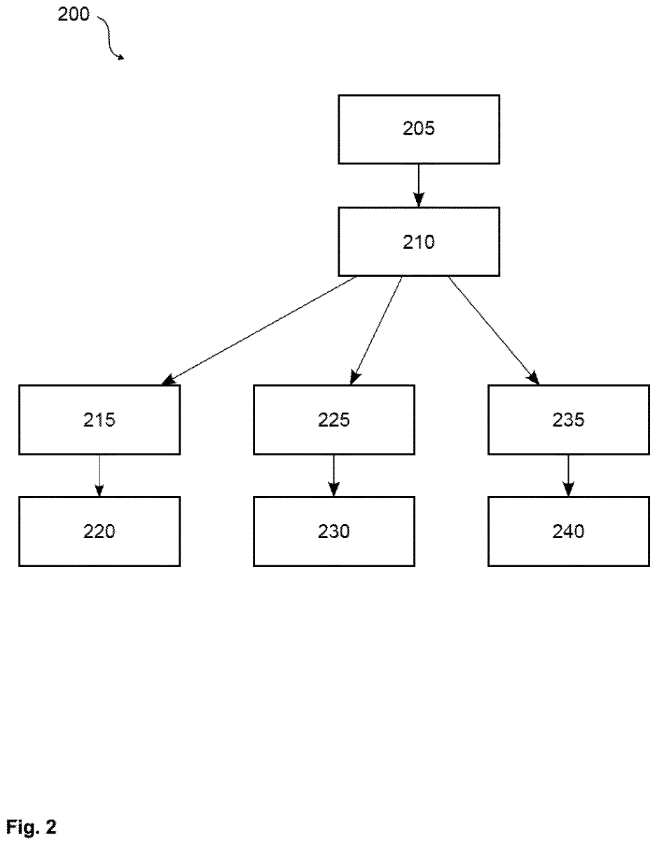

FIG. 2 shows a flow chart of an exemplary method 200 for controlling communication between a motor vehicle 105 or a device 125 and a mobile device 110. It is preferably determined in a step 205 that the motor vehicle 105 is parked. In the parked state, a driving function of the motor vehicle 105 is inactive and the motor vehicle 105 is typically not located in public road traffic. In a step 210, a transmission situation of the motor vehicle 105 or in the area of the motor vehicle 105 can be determined. The transmission situation can relate, on the one hand, to how radio waves propagate in the area of the motor vehicle 105 in the direction of a mobile device 110 and/or, on the other hand, where a mobile device 110 can be located with respect to the motor vehicle 105.

In a first variant, it can be determined in a step 215 that a mobile device 110 is located in the interior 115 of the motor vehicle 105. Thereupon, in a step 220, a transmitting power of an external transmission device 135 of the motor vehicle 105 can be reduced. Such a situation is present, for example, when a person with the mobile device 110 has entered the motor vehicle 105 and communication takes place between the mobile device 110 and an internal transmission device 135. For example, the person can carry out owner pairing with the motor vehicle 105, which is sensitive for security technology and comprises establishing an assignment between the mobile device 110 and the motor vehicle 105 in order to be able subsequently to control a predetermined security function of the motor vehicle 105 by means of the mobile device 110.

In a second variant, in a step 225, an obstacle 140 in the area of the motor vehicle 105 can be determined, which influences a propagation of radio waves. The obstacle 140 can be determined in particular on the basis of a determined geographic position and corresponding map data.

In a step 230, a transmitting power of a transmission device 135 can then be reduced in the direction of the obstacle 140. In particular, a transmitting power of an external transmission device 135, which faces toward the obstacle 140, can be reduced. A transmitting power of a further transmission device 135, in particular an external transmission device 135 which faces away from the obstacle 140, can be maintained or even increased.

In a third variant, in a step 235, an obstacle 140 in the area of the motor vehicle 105 can be determined, which applies to a person who approaches the motor vehicle 105 with a mobile device 110. In a corresponding manner, a path can be determined on which a person with the mobile device 110 can approach the motor vehicle 105. Based thereon, an area can be determined, of which it is to be presumed that it cannot or will not be used by a person with the mobile device 110. A coverage of such an area with radio waves can be reduced in a step 240. For this purpose, a transmitting power of a transmission device 135, which is configured to transmit radio waves in such an area, can be reduced. In one embodiment, the transmission device 135 can also be completely deactivated. If the transmission device 135 is configured to supply both a usable and a non-usable area in the surroundings of the motor vehicle 105 with radio waves, a matching compromise can be found in which sufficiently good coverage of a usable area and the least possible coverage of a non-usable area are unified with one another.

It is to be noted that each of the described variants is combinable with another variant. In all cases, transmitting powers of transmission devices 135 are adapted depending on a transmission situation of the motor vehicle 105, so that an overall transmitting power which comprises transmitting powers of all transmission devices 135 is reduced, with the goal of reducing an overall energy consumption, which comprises energy consumptions of all transmission devices 135. The transmitting power of a transmission device 135 is preferably controlled depending on its position on the motor vehicle 105. In addition, the transmitting power can be controlled depending on a relative location of a transmission device 135 with respect to an object 140 in the surroundings of the motor vehicle 105.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### REFERENCE SIGNS

100 system
105 motor vehicle
110 mobile device
115 interior
120 exterior
125 device
130 processing device
135 transmission device
140 object
145 positioning device
150 map memory
200 method
205 motor vehicle parked
210 determine transmission situation
215 mobile device in interior
220 reduce transmitting power in exterior
225 obstacle to radio waves
230 reduce transmitting power on facing side
235 obstacle to approach
240 reduce transmitting power outside path/in unreachable area

What is claimed is:

1. A method for wireless communication of a motor vehicle with a mobile device, the method comprising:
determining a transmission situation of the motor vehicle for radio waves;
adapting a transmitting power of at least one wireless transmission device of the motor vehicle depending on the transmission situation to reduce an overall energy consumption of the at least one transmission device.

2. The method according to claim 1, wherein a plurality of transmission devices are provided at different positions of the motor vehicle, and wherein the transmitting power of the at least one transmission device is adapted depending on a position of the at least one transmission device and the transmission situation.

3. The method according to claim 2, wherein a ratio of transmitting powers of different transmission devices is adapted.

4. The method according to claim 1, wherein the transmission situation comprises that the mobile device is located in an interior of the motor vehicle, and wherein a transmitting power of the at least one transmission device is adapted so that communication with a mobile device outside the interior is made more difficult.

5. The method according to claim 2, wherein the transmission situation comprises that the mobile device is located in an interior of the motor vehicle, and wherein a transmitting power of the at least one transmission device is adapted so that communication with a mobile device outside the interior is made more difficult.

6. The method according to claim 4, wherein a transmitting power of a transmission device configured for communication outside the interior is reduced.

7. The method according to claim 1, wherein the transmission situation comprises that the motor vehicle is surrounded in a horizontal direction by building structures, and wherein the transmitting power of the at least one transmission device is reduced.

8. The method according to claim 2, wherein the transmission situation comprises that the motor vehicle is surrounded in a horizontal direction by building structures, and wherein the transmitting power of the at least one transmission device is reduced.

9. The method according to claim 7, wherein the transmission situation comprises that the motor vehicle is located in a building.

10. The method according to claim 8, wherein the transmission situation comprises that the motor vehicle is located in a building.

11. The method according to claim 1, wherein the transmission situation comprises that the motor vehicle stands at an obstacle, and wherein a transmitting power of a transmission device facing toward the obstacle is reduced.

12. The method according to claim 2, wherein the transmission situation comprises that the motor vehicle stands at an obstacle, and wherein a transmitting power of a transmission device facing toward the obstacle is reduced.

13. The method according to claim 1, wherein the transmission situation comprises that an approach of the mobile device to the motor vehicle is only possible on a predetermined path, and wherein a transmitting power of a transmission device which is not configured to communicate with a mobile device located on the path is reduced.

14. The method according to claim 2, wherein the transmission situation comprises that an approach of the mobile device to the motor vehicle is only possible on a predetermined path, and wherein a transmitting power of a transmission device which is not configured to communicate with a mobile device located on the path is reduced.

15. The method according to claim 1, wherein the transmission situation comprises that an approach of a mobile device to the motor vehicle from a predetermined direction is not to be expected, and wherein a transmitting power of a transmission device configured to communicate with a mobile device located in the predetermined direction is reduced.

16. The method according to claim 1, wherein the motor vehicle is parked.

17. The method according to claim 1, wherein communication is established between the mobile device and the motor vehicle, wherein the mobile device is authenticated, and wherein a predetermined function of the motor vehicle is controlled.

18. A device for a motor vehicle, for wireless communication with a mobile device, the device comprising:
at least one wireless transmission device;
a device configured to determine a transmission situation of the motor vehicle; and
a processing device configured to adapt a transmitting power of the at least one transmission device depending on the transmission situation to reduce an overall energy consumption of the at least one transmission device.

19. The device according to claim 18, wherein the device comprises a positioning device configured to determine a geographic position of the motor vehicle and a map memory that stores map data.

20. A motor vehicle comprising a device according to claim
